(19) United States
(12) Patent Application Publication
(10) Pub. No.: US 2007/0002585 A1
(43) Pub. Date: Jan. 4, 2007

(54) Backlight unit

(75) Inventors: Man Hoan Lee, Seoul (KR); Ji Su Yoon, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 11/312,470

(22) Filed: Dec. 21, 2005

(30) Foreign Application Priority Data
Jun. 29, 2005 (KR) P 2005-56979

(51) Int. Cl. F21V 13/04

(52) U.S. Cl. 362/607; 362/613; 362/330; 362/331

(57) ABSTRACT

A backlight unit includes a first lamp to emit light, a light-guiding plate to generate a surface light source with the light emitted from the first lamp, a light-diffusion sheet provided on the light-guiding plate to diffuse the light passing through the light-guiding plate, a prism sheet including a plurality of prism peaks arranged in a first direction, for condensing the light passing through the light-diffusion sheet, and a lenticular lens sheet including a plurality of lenticular lenses arranged in a second direction perpendicular to the first direction, for re-condensing the light passing through the prism sheet.

This application claims the benefit of the Korean Patent Application No. P2005-0056979, filed on Jun. 29, 2005, which is hereby incorporated by reference.

### BACKGROUND OF THE INVENTION

1. Field of the Invention

The present invention relates to a backlight unit, and more particularly, to a backlight unit that is capable of improving light efficiency and viewing angles.

2. Discussion of the Related Art

Recently, various flat displays have been developed to substitute cathode ray tube (CRT). Among these flat displays, liquid crystal display (LCD) devices, field emission displays (FEDs), plasma display panel (PDPs), and light emitting displays (LEDs) have attracted considerable attention. The LCD device includes an LCD panel and a backlight unit. The LCD panel is provided with a plurality of liquid crystal cells and a plurality of control switches for switching video signals supplied to the liquid crystal cells. The backlight unit emits light as a light source. The LCD panel displays picture images by controlling light transmittance of the light emitted from the backlight unit.

FIG. 1 is a schematic view illustrating a backlight unit according to the related art. As shown in FIG. 1, the related art backlight unit includes a lamp 10, a light-guiding plate 20, a lamp housing 12, a reflecting plate 30, a light-diffusion sheet 40, and first and second prism sheets 50 and 60. Herein, the lamp 10 emits light toward the light-guiding plate 20. The light-guiding plate 20 receives the light from the lamp 10 through an incident surface 22 provided at one side of the light-guiding plate 20 and generates a surface light source. The lamp housing 12 surrounds the incident surface 22 and the lamp 10, so that the light emitted from the lamp 10 is condensed to one direction. The reflecting plate 30 is provided below the light-guiding plate 20 to reflect the light. The light-diffusion sheet 40 is provided on the light-guiding plate 20 to diffuse the light passing through the light-guiding plate 20. The first and second prism sheets 50 and 60 control a progressing direction of the light passing through the light-diffusion sheet 40.

Generally, the lamp 10 is a cold cathode fluorescent lamp. Although not shown, when an inverter applies a driving voltage to the lamp 10, the lamp 10 is turned-on. Thus, the light emitted from the lamp 10 is incident upon the incident surface 22 provided at one side of the light-guiding plate 20. Also, the lamp housing 12 is provided at the same side of the light-guiding plate 20 so as to surround the lamp 10 and the incident surface 22 of the light-guiding plate 20. The lamp housing 12 has an inner reflecting surface that reflects the light emitted from the lamp 10 toward the incident surface 22 of the light-guiding plate 20.

The light-guiding plate 20 guides the light from the lamp 10 toward the light-diffusion sheet 40, which is located apart from the lamp 10. The light-guiding plate 20 includes an inclined rear surface that is formed with a light-diffusion pattern. When the incident light is reflected on the inclined rear surface to a predetermined angle, the light can be uniformly guided to the light-diffusion sheet 40. Moreover, the reflecting plate 30 is provided below the light-guiding plate 20. When the light reaches the reflecting plate 30 through the rear surface of the light-guiding plate 20, the reflecting plate 30 reflects the light toward the light-guiding plate 20, thereby reducing the loss of the light.

The light-diffusion sheet 40 diffuses the light passing through the light-guiding plate 20 to an entire area thereof, so that the diffused light reaches the first prism sheet 50. Meanwhile, when the light is incident perpendicular to the LCD panel (not shown), it is possible to maximize the light efficiency. To obtain a progressing angle of the light perpendicular to the LCD panel, it is preferable to provide two prism sheets. Herein, the first and second prism sheets 50 and 60 condense the light passing through the light-diffusion sheet 40.

As shown in FIG. 2, each of the first and second prism sheets 50 and 60 includes a light-condensing film 52 and a plurality of prism peaks 54. The light-condensing film 52 is formed of polyester PET. Also, the plurality of prism peaks 54 are formed in a stripe shape. The prism peaks 54 have first and second tilt surfaces tilted from their angular points at a predetermined angle. Each of the first and second tilt surfaces is tilted from a top surface of the condensing film 52 at an angle of 45°.

When the incident light reaches the first and second prism sheets 50 and 60 at a predetermined angle θ1 having a refractive index n1, the light is refracted by the first and second prism sheets 50 and 60 at a predetermined angle θ2 under the Snell's law expressed in the following equation 1 and is then emitted to the outside having a refractive index n2.

$$\frac{n 1}{n 2} = \frac{sin θ 1}{sin θ 2} \qquad equation 1$$

In the related art backlight unit, the light emitted from the lamp 10 proceeds to the light-diffusion sheet 40 through the light-guiding plate 20, and then the light-diffusion sheet 40 diffuses the light passing through the light-guiding plate 20 to the entire regions thereof. After that, the diffused light is condensed through the first and second prism sheets 50 and 60. The condensed light is finally emitted to the outside.

However, as shown in FIG. 3, in the related art backlight unit, the incident light to the first and second prism sheets 50 and 60 can be split into three regions, namely, a total reflection region, a condensing region, and a side lobe region. Specifically, in the total reflection region, light A vertically enters the condensing film 52 and is totally reflected by the first and second tilt surfaces of the prism peaks 54. The totally reflected light proceeds to the light-guiding plate 20. In this way, the light A is condensed by recycling. In the condensing region, light B enters the condensing film 52 at a predetermined angle and is condensed in such a manner that it is refracted by the first and second tilt surfaces of the prism peaks 54. In the side lobe region, light C enters the condensing film 52 at a predetermined angle and is totally reflected by the first and second tilt surfaces of the prism peaks 54. Thus, in this related art backlight unit, both the light efficiency and viewing angle characteristics are deteriorated.

As shown in FIG. 4, the first and second prism sheets 50 and 60 have a better condensing efficiency in a vertical axis (Y axis) than in a horizontal axis (X axis) due to a two-dimensional structure of the prism peaks 54. Accordingly, as shown in FIG. 5, a bright region exists at both sides of each of the first and second prism sheets 50 and 60 around a symmetrical point due to the side lobe region.

The related art backlight unit has the following disadvantages. Due to the arrangement and structure of the first and second prism sheets, the viewing angle characteristics are deteriorated by luminance asymmetry in the vertical and horizontal axes (Y and X axes). Also, the condensing efficiency is deteriorated by the side lobe region.

### SUMMARY OF THE INVENTION

Accordingly, the present invention is directed to a backlight unit that substantially obviates one or more problems due to limitations and disadvantages of the related art.

An object of the present invention is to provide a backlight unit that is capable of improving the light efficiency and viewing angle in a prism sheet.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a backlight unit comprises a first lamp to emit light, a light-guiding plate to receive the light emitted from the first lamp to generate a surface light source, a light-diffusion sheet provided on the light-guiding plate to diffuse the light passing through the light-guiding plate, a prism sheet including a plurality of prism peaks arranged in a first direction, to condense the light passing through the light-diffusion sheet, and a lenticular lens sheet including a plurality of lenticular lenses arranged in a second direction perpendicular to the first direction, to re-condense the light passing through the prism sheet.

In another aspect of the present invention, a backlight unit comprises a first lamp to emit light, a light-guiding plate including an incident surface at one side thereof to change a progressing direction of the light emitted from the first lamp to be vertical, a prism sheet to condense the light passing through the light-guiding plate in a vertical direction, and a lenticular lens sheet to re-condense the light passing through the prism sheet in a horizontal direction.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a schematic view illustrating a backlight unit according to the related art;

FIG. 2 is a perspective view illustrating a prism sheet of the backlight unit shown in FIG. 1;

FIG. 3 is a schematic view illustrating the light efficiency of prism peaks of the prism sheet shown in FIG. 2;

FIG. 4 is a graph illustrating the luminance by an angle of the prism sheet shown in FIG. 2;

FIG. 5 is a schematic view illustrating the light transmittance and angle distribution in the prism sheet of FIG. 2;

FIG. 6 is a schematic view illustrating a backlight unit according to one exemplary embodiment of the present invention;

FIG. 7 is a graph showing the luminance depending on an angle of a lenticular lens sheet of the backlight unit shown in FIG. 6;

FIG. 8 illustrates the profile of light passing through a prism sheet and a lenticular lens sheet of the backlight unit shown in FIG. 6; and

FIG. 9 is a schematic view illustrating a backlight unit according to another exemplary embodiment of the present invention.

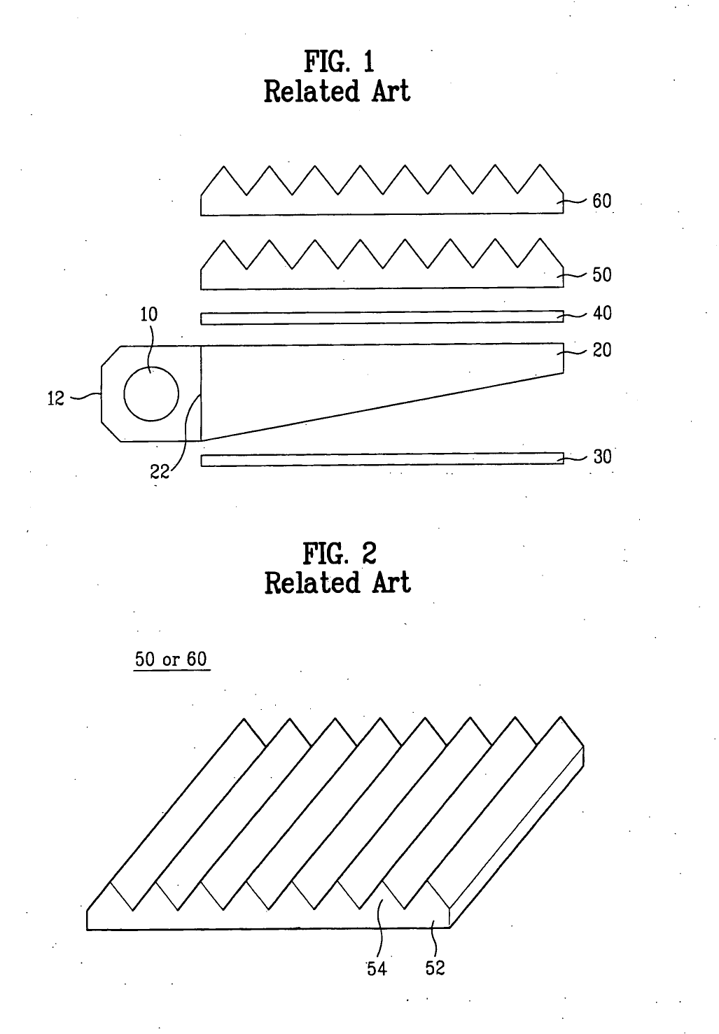

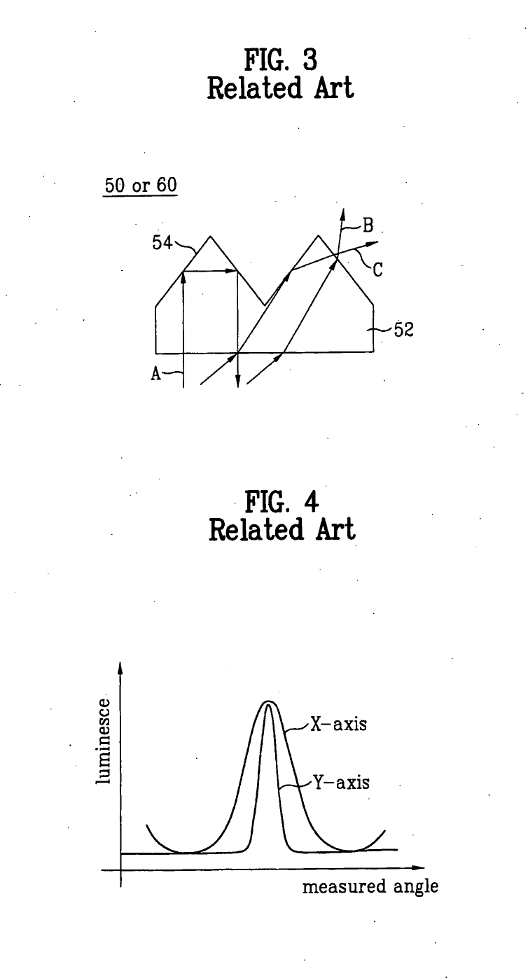

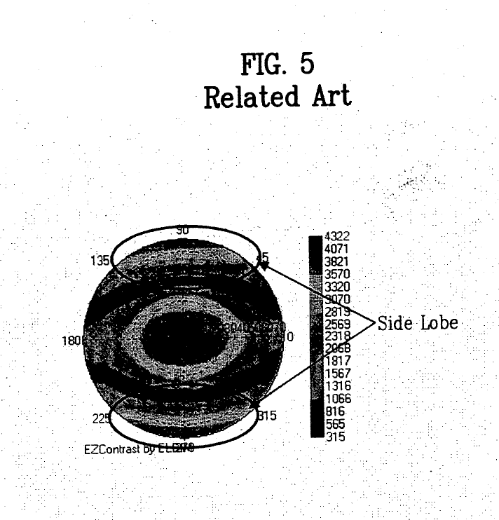

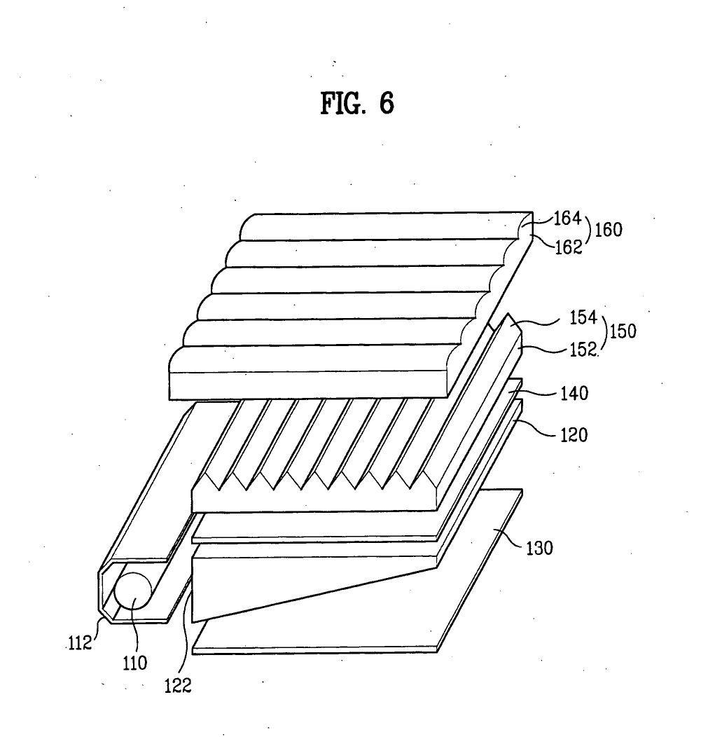

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

FIG. 6 is a schematic view illustrating a backlight unit according to one exemplary embodiment of the present invention. As shown in FIG. 6, the backlight unit includes a lamp 110, a light-guiding plate 120, a lamp housing 112, a reflecting plate 130, a light-diffusion sheet 140, a prism sheet 150, and a lenticular lens sheet 160.

In this exemplary embodiment, the lamp 110 emits light as a light source. The light-guiding plate 120 receives the light emitted from the lamp 110 through an incident surface 122 provided on one side of the light-guiding plate 120, and generates a surface light source. The lamp housing 112 surrounds the incident surface 122 of the light-guiding plate 120 and the lamp 110. The reflecting plate 130 is provided below the light-guiding plate 120 to reflect the light. The light-diffusion sheet 140 is provided on the light-guiding plate 120 to diffuse the light passing through the light-guiding plate 120. The prism sheet 150 is formed with a plurality of prism peaks 154 arranged in a first direction (Y-axis direction) for condensing the light passing through the light-diffusion sheet 140. The lenticular lens sheet 160 is formed with a plurality of lenticular lenses 164 for re-condensing the light passing through the prism sheet 150. The plurality of lenticular lenses 164 are arranged in a second direction (X-axis direction) perpendicular to the first direction.

Generally, the lamp 110 may be a cold cathode fluorescent lamp. When an inverter (not shown) applies a driving voltage to the lamp 110, the lamp 110 is turned-on. The light emitted from the lamp 110 is incident upon the incident surface 122 provided at one side of the light-guiding plate 120. The lamp housing 112 is provided at the same side of the light-guiding plate 120 so as to surround the lamp 110 and the incident surface 122. The lamp housing 112 includes an inner reflecting surface that reflects the light emitted from the lamp 110 toward the incident surface 122 of the light-guiding plate 120.

The light-guiding plate 120 serves to guide the light toward the light-diffusion sheet 140, which is located apart from the lamp 110. Also, the light-guiding plate 120 includes an inclined rear surface that is formed with a light-diffusion pattern to reflect the incident light at a predetermined angle. The light is thus uniformly guided to the light-diffusion sheet 140. Moreover, the reflecting plate 130 is provided below the light-guiding plate 120. When the light reaches the reflecting plate 130 through the rear surface of the light-guiding plate 120, the reflecting plate 130 reflects the light toward the light-guiding plate 120, thereby reducing the loss of the light.

The light-diffusion sheet 140 diffuses the light passing through the light-guiding plate 120 to an entire area thereof, and thus the diffused light reaches the prism sheet 150. When the light is incident perpendicular to the liquid crystal panel (not shown), it is possible to maximize the light efficiency. To obtain a progressing angle of the light perpendicular to the liquid crystal panel, it is preferable to provide the two prism sheets. The prism sheet 150 condenses the light passing through the light-diffusion sheet 140. In this exemplary embodiment, the prism sheet 150 includes a first condensing film 152 and a plurality of prism peaks 154. The light-condensing film 152 is formed of polyester PET, and the plurality of prism peaks 154 are formed in a stripe shape. Each of the prism peaks 154 includes first and second tilt surfaces tilted from its angular point at a predetermined angle. Each of the first and second tilt surfaces is tilted from a top surface of the first condensing film 152 at an angle of 45°. Moreover, the prism sheet 150 has a better condensing efficiency in a vertical axis (Y axis) than in a horizontal axis (X axis) due to a two-dimensional structure of the prism peaks 154.

The lenticular lens sheet 160 includes a second condensing film 162 and the plurality of lenticular lenses 164. The plurality of lenticular lenses 164 are formed on the second condensing film 162 in the second direction (X-axis direction) as a stripe shape. Each of the lenticular lenses 164 includes a cross section of a curved shape such as a semicircle, an elliptical, a cardioid, a cycloid, or the like. In this exemplary embodiment, the plurality of lenticular lenses 164 are formed on the second condensing film 162 in a stripe shape.

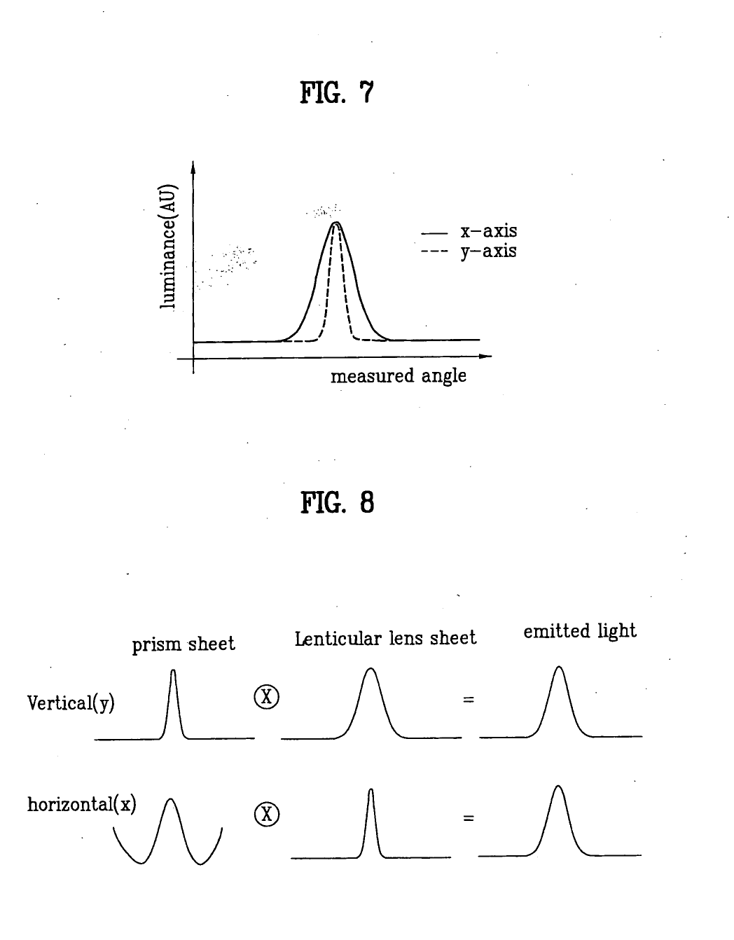

FIG. 7 is a graph showing the luminance depending on an angle of the lenticular lens sheet 160 of FIG. 6. As shown in FIG. 7, the lenticular lens sheet 160 has a better condensing efficiency in the horizontal axis (X-axis) than in the vertical axis (Y-axis) due to a two-dimensional structure of the lenticular lenses 164. Accordingly, the lenticular lens sheet 160 re-condenses the light in the vertical axis (Y-axis), wherein the light is already condensed in the horizontal axis (X-axis) by the prism sheet 150.

In the backlight unit according to the exemplary embodiment of the present invention, the light emitted from the lamp 110 is guided to the light-diffusion sheet 140 through the light-guiding plate 120. Then, the light-diffusion sheet 140 diffuses the light passing through the light-guiding plate 120 to the entire regions. After that, the diffused light is condensed to the vertical direction (Y-axis) through the prism sheet 150. The light passing through the prism sheet 150 is re-condensed in the horizontal direction (X-axis) through the lenticular lens sheet 160, and then the light is emitted to the outside.

FIG. 8 illustrates a profile of the light passing through the prism sheet 150 and the lenticular lens sheet 160 of FIG. 6. As shown in FIG. 8, the transmittance characteristics of the light emitted to the outside is determined with the multiplication of the prism sheet 150 and the lenticular lens sheet 160. In the backlight unit according to the exemplary embodiment of the present invention, the prism sheet 150 intersects the lenticular lens sheet 160. Thus, it is possible to prevent an asymmetric viewing angle caused by the difference in condensing the light in the horizontal (X-axis) and vertical (Y-axis) directions of the prism sheet 150, and to prevent a side lobe in the horizontal direction (Y-axis). Moreover, the prism sheet 150 intersects the lenticular lens sheet 160, thereby improving the light efficiency and viewing angle.

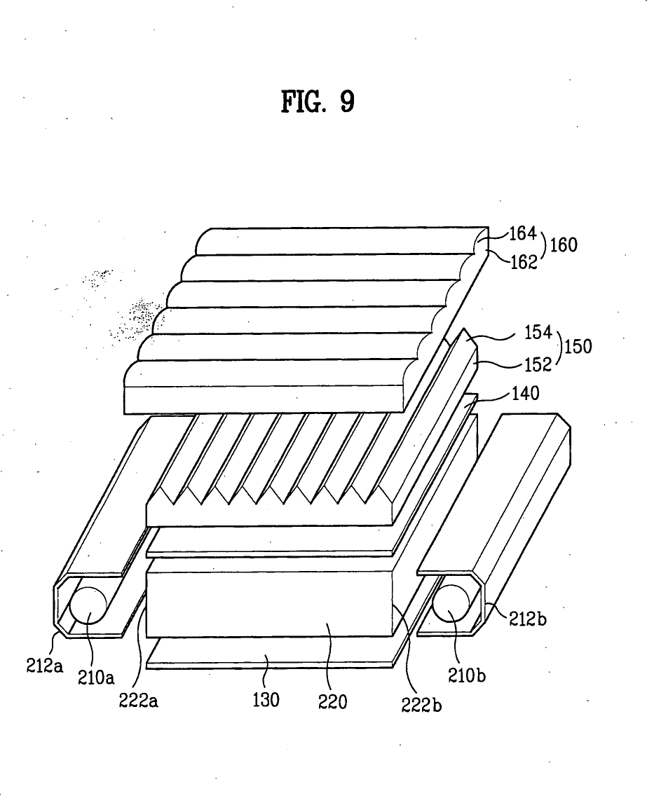

FIG. 9 illustrates a backlight unit according to another exemplary embodiment of the present invention. As shown in FIG. 9, the backlight unit includes a plane type light-guiding plate 220, at least two lamps 210a and 210b, lamp housings 212a and 212b, a reflecting plate 130, a light-diffusion sheet 140, a prism sheet 150, and a lenticular lens sheet 160.

In this exemplary embodiment, the light-guiding plate 220 includes two incident surfaces 222a and 222b that are formed respectively at two sides of the light-guiding plate 220. The at least two lamps 210a and 210b are provided in correspondence with the respective incident surfaces 222a and 222b. Also, the lamp housings 212a and 212b respectively surround the incident surfaces 222a and 222b and the lamps 210a and 210b. The reflecting plate 130 is provided below the light-guiding plate 220. The light-diffusion sheet 140 is provided on the light-guiding plate 220 to diffuse the light passing through the light-guiding plate 220. Also, the prism sheet 150 includes a plurality of prism peaks 154 arranged in a first direction (Y-axis direction) for condensing the light passing through the light-diffusion sheet 140. The lenticular lens sheet 160 includes a plurality of lenticular lenses 164 arranged in a second direction (X-axis direction) perpendicular to the first direction, for re-condensing the light passing through the prism sheet 150.

Unlike the exemplary embodiment of FIG. 6, in this exemplary embodiment of FIG. 9, the at least two lamps 210a and 210b are provided in correspondence with the respective incident surfaces 222a and 222b of the light-guiding plate 220. The light emitted from the lamps 210a and 210b is incident through the incident surfaces 222a and 222b respectively formed at both sides of the light-guiding plate 220, thereby improving the luminance of light. Also, the prism sheet 150 intersects the lenticular lens sheet 160, thereby improving the light efficiency of the prism sheet 150 and the viewing angle.

As mentioned above, the backlight unit of the exemplary embodiments according to the present invention has the following advantages. The prism peaks of the prism sheet intersect the lenticular lenses of the lenticular lens sheet, thereby improving the light efficiency of prism sheet and the viewing angle. Also, such an arrangement of the exemplary embodiment provides for an improved symmetry of viewing angle and an improved contrast ratio with an improved light-condensing efficiency.

It will be apparent to those skilled in the art that various modifications and variations can be made in the backlight unit of the present invention without departing from the spirit or scope of the inventions. Thus, it is intended that the present invention covers the modifications and variations of this invention provided they come within the scope of the appended claims and their equivalents.

What is claimed is:

1. A backlight unit comprising:
a first lamp to emit light;
a light-guiding plate to receive the light emitted from the first lamp to generate a surface light source;
a light-diffusion sheet provided on the light-guiding plate to diffuse the light passing through the light-guiding plate;
a prism sheet including a plurality of prism peaks arranged in a first direction, to condense the light passing through the light-diffusion sheet; and
a lenticular lens sheet including a plurality of lenticular lenses arranged in a second direction perpendicular to the first direction, to re-condense the light passing through the prism sheet.

2. The backlight unit of claim 1,
wherein the prism sheet further includes a first light-condensing film to which the light is incident through the light-guiding plate; and
wherein the plurality of prism peaks include angular points on the first light-condensing film and are arranged along the first direction in parallel as a stripe shape.

3. The backlight unit of claim 1,
wherein the lenticular lens sheet further includes a second light-condensing film to which the light is incident through the prism sheet; and
wherein the plurality of lenticular lenses are formed on the second light-condensing film along the second direction in parallel as a stripe shape.

4. The backlight unit of claim 1, wherein each of the plurality of lenticular lenses includes a cross section of a curved shape, the curved shape being one of a semicircle, an elliptical, a cardioid, and a cycloid.

5. The backlight unit of claim 1, wherein the first lamp is provided at a first side of the light-guiding plate.

6. The backlight unit of claim 1, further comprising:
a lamp housing provided at the first side of the light-guiding plate to surround an incident surface of the light-guiding plate and the first lamp; and
a reflecting plate provided below the light-guiding plate.

7. The backlight unit of claim 1, further comprising:
a second lamp to emit light, wherein the second lamp is provided at a second side of the light guiding plate.

8. The backlight unit of claim 7, further comprising:
a lamp housing provided at the second side of the light-guiding plate to surround an incident surface of the light-guiding plate and the second lamp; and
a reflecting plate provided below the light-guiding plate.

9. The backlight unit of claim 7, wherein the second side is the side of the light guiding plate opposite to the first side.

10. A backlight unit comprising:
a first lamp to emit light;
a light-guiding plate including an incident surface at a first side thereof to change a progressing direction of the light emitted from the first lamp to be vertical;
a prism sheet to condense the light passing through the light-guiding plate in a vertical direction; and
a lenticular lens sheet to re-condense the light passing through the prism sheet in a horizontal direction.

11. The backlight unit of claim 10, wherein the prism sheet is positioned on the light-guiding plate in a first direction, and the lenticular lens sheet is positioned on the prism sheet in a second direction.

12. The backlight unit of claim 11,
wherein the prism sheet further includes a first light-condensing film to which the light is incident through the light-guiding plate; and
wherein the plurality of prism peaks include angular points on the first light-condensing film and are arranged along the first direction in parallel as a stripe shape.

13. The backlight unit of claim 11,
wherein the lenticular lens sheet further includes a second light-condensing film to which the light is incident through the prism sheet; and
wherein the plurality of lenticular lenses are formed on the second light-condensing film along the second direction in parallel as a stripe shape.

14. The backlight unit of claim 13, wherein each of the lenticular lenses includes a cross section of a curved shape, the curved shape being one of a semicircle, an elliptical, a cardioid and a cycloid.

15. The backlight unit of claim 10, wherein the first lamp is provided at a first side of the light-guiding plate.

16. The backlight unit of claim 7, further comprising:
a lamp housing provided at the first side of the light-guiding plate to surround the incident surface of the light-guiding plate and the first lamp;
a light-diffusion sheet provided between the light-guiding plate and the prism sheet to diffuse the light passing through the light-guiding plate; and
a reflecting plate provided below the light-guiding plate.

17. The backlight unit of claim 10, further comprising:
a second lamp to emit light, wherein the second lamp is provided at a second side of the light guiding plate.

18. The backlight unit of claim 17, further comprising:
a lamp housing provided at the second side of the light-guiding plate to surround an incident surface of the light-guiding plate and the second lamp; and
a reflecting plate provided below the light-guiding plate.

19. The backlight unit of claim 17, wherein the second side is the side of the light guiding plate opposite to the first side.
